(19) United States
(12) Patent Application Publication
(10) Pub. No.: US 2019/0173294 A1
(43) Pub. Date: Jun. 6, 2019

(54) EYEWEAR CASE WITH MULTIPLE-DEVICE RECHARGING CAPABILITIES

(71) Applicant: EYEJUICE INNOVATIONS INC.

(72) Inventor: Jason PAULSON, Stony Plain (CA)

(21) Appl. No.: 16/068,659

(22) PCT Filed: May 19, 2017
(86) PCT No.: PCT/IB2017/052963

§ 371 Date: Jul. 6, 2018

(30) Foreign Application Priority Data
Mar. 18, 2017 (IB) PCT/IB2017/000263

(51) Int. Cl. H02J 7/00; H02J 7/35; H02J 7/02; A45C 11/04; A45C 15/00; H04R 1/02; H04R 3/00

(52) U.S. Cl. CPC H02J 7/0021; H02J 7/355; H02J 7/025; H02J 2007/0096; A45C 15/00; H04R 1/028; H04R 3/00; A45C 11/04

(57) ABSTRACT

The disclosed is an eyewear case for driving and recharging multiple-types of electrically driven devices. The eyewear case comprises a power input port, one or more batteries and power output ports in combination with a variety of components if desired, so as to protect the eyewear, recharge and drive electrically driven devices, support and fix these devices thereon, have a wide range of compatibilities to these devices, store data, control and adjust charging/recharging conditions, act as a wireless access point as well as a media bridge server, broadcast sounds, display a variety of information and so forth, wherein the apparatus can also be recharged by either an external power source or solar panel. Through the present invention, a user can find additional usefulness for an eyewear case, more than providing protection to eyewear.

### CROSS-REFERENCE TO RELATED APPLICATION

This application claims priority from the PCT Application No. PCT/IB2017/000263 filed on Mar. 28, 2016 at the WIPO, the content of which is hereby incorporated by reference in its entirety for all purposes.

### BACKGROUND OF THE INVENTION

### 1. Field of the Invention

Eyewear cases have been a ubiquitous fixture since the first eyeglass wearer broke his pair of glasses. The case obviously provides a way of storing the eyeglasses when they are not in use, or when it is desirable to protect them from the outside environment.

### 2. Description of the Related Art

Commensurate with the development of eyeglass or eyewear cases has been the design of the case. Cases have usually been bulky to account for the size of the glasses. In recent decades, they have been streamlined to allow ease of carry. For example, the “mummy” style, where eyeglasses are slipped into the case, possesses no hinge, thus allowing a hard shell design and a slim style in the same package.

However, for the past 10 years, the “bulk” of items carried by the average person has grown significantly. These usually include the cellular phone, wallet, keys, etc. To put it simply, people's pockets are now busting from the seams. Eyeglass wearers have the additional baggage of carrying an eyewear case.

While it is difficult to reduce the current personal baggage of the average pedestrian, the present invention provides eyeglass wearer's a tool to both protect their eyewear and provide additional useful accoutrements that will improve their daily outings.

The present invention improves upon the basic eyeglass case by developing an apparatus for carrying eyewear, wherein the apparatus can further recharge or drive other electrically driven devices, be recharged via solar panel or external power source in a variety of ways, store data as a portable data storage, act as a wireless access point as well as a media bridge server, broadcast sounds as a speaker, recording sounds as a recorder, display information in a plurality of forms, locate the position of itself, and so forth. All of the aforementioned functions can be included within a centralized housing for protecting the eyewear. Through the present invention, a user can find additional usefulness for an eyewear case more than just providing protection to the eyewear, and reduce the bulk of baggage by integrating multiple functions into only one apparatus.

### SUMMARY OF THE INVENTION

According to the description above, the purpose of present invention is about to provide an eyewear case for driving and recharging multiple-types of electrically driven devices, so as to solve the aforementioned issues.

In accordance with the purpose of the present invention, an eyewear case for driving and recharging multiple-types of electrically driven devices is provided. The eyewear case for driving and recharging multiple-types of electrically driven devices comprises a first portion having a first cavity, a second portion having a second cavity, a coupling mechanism joining the first portion and the second portion together, one or more rechargeable batteries configured at one or both of the first portion and the second portion, an power input port configured at one of the first portion and the second portion as well as electrically connecting with the one or more rechargeable batteries, one or more power output ports configured at one or both of the first portion and the second portion as well as electrically connecting with the one or more rechargeable batteries, a switch configured at one or both of the first portion and the second portion as well as electrically connected between the one or more rechargeable batteries and the one or more power output ports to control an electrical connection therebetween for recharging the multiple-types of electrically driven devices, and a battery meter configured at an exterior of one or both of the first portion and the second portion, wherein the first portion and the second portion are operable to collaboratively enclose an accommodating space which is formed of the first cavity and the second cavity for storing an eyewear or make the accommodating space accessible from outside by operating the coupling mechanism.

Preferably, wherein the coupling mechanism is selected from one or more of a hinge for coupling the first portion and the second portion in a rotatable manner, a sliding mechanism for coupling the first portion and the second portion in a sliding manner, a pair of magnetized elements configured on the first portion and the second portion respectively, and a male joint as well as a female joint formed on the first portion and the second portion respectively so as to couple the first portion and the second portion by inserting the male joint into the female joint.

Preferably, the eyewear case comprises a pop-up mechanism which is connected to the coupling mechanism, such that the pop-up mechanism sticks out the eyewear stored in the accommodating space when the accommodating space becomes accessible from outside by operating the coupling mechanism and retrieves the eyewear back to the accommodating space when the accommodating space becomes enclosed by operating the coupling mechanism.

Preferably, the eyewear case comprises a support unit which is configured at the exterior of one of the first portion and the second portion for fixing one of the first portion and the second portion by an oblique angle with respect to each other, so as to support the multiple-types of electrically driven devices put thereon, wherein the support unit is retrievable.

Preferably, wherein the power input port and the one or more power output ports are selected from one or more of universal serial bus (USB) 1.0, USB 2.0. USB 3.0, USB 3.1, USB-A, USB-B, USB-mini A, USB-mini B, USB-C, and lighting cables.

Preferably, wherein both the power input port and the one or more power output ports have inductive coils which are electrically connected with an external power source and the multiple-types of electrically driven devices respectively.

Preferably, the eyewear case comprises a solar panel configured on the exterior of one or both of the first portion and the second portion, wherein the solar panel is electrically connected to the one or more rechargeable batteries.

Preferably, the eyewear case comprises a data storage unit selected from one or more of hard drives, solid state drives (SSD), secure digital (SD) memory cards and universal serial bus (USB) thumb drives.

Preferably, the eyewear case comprises a computing module which is a printed circuit board (PCB). The computing module includes a central processing unit (CPU), a memory unit selected from one or more of Cache and random-access memory (RAM), a subscriber identity module (SIM) port configured at the PCB, and a plurality of functional circuits for performing controls of charging the batteries and recharging the multiple-types of electrically driven devices, wherein the computing module is connected to the one or more rechargeable batteries, the power input port, the one or more power output ports, the switch, the battery meter and the data storage unit.

Preferably, the eyewear case comprises an internet connecting module, which distributes external signals to the multiple-types of electrically driven devices as a wireless access point, and connects an external signal source with the multiple-types of electrically driven devices as a media bridge server.

Preferably, the eyewear case comprises an audible unit configured at one or both of the first portion and the second portion, wherein the audible unit includes a speaker as well as a microphone, and connected to the data storage unit, the computing module as well as the internet connecting module for broadcasting sounds according to data from the data storage unit, the external signal source as well as the one or more power output ports and recording external sounds on the data storage unit.

Preferably, the eyewear case comprises a display screen which is configured at one or both of the first portion and the second portion, wherein the display screen is connected to the data storage unit, the computing module, the internet connecting module and the audible unit for displaying information selected from one or more of texts, photos and videos according to the data from the data storage unit, the external signal source as well as the one or more power output ports.

Preferably, wherein connecting types to the external signal source is selected from one or more of hardwire, Zigbee protocol, wireless fidelity (WIFI) protocol, local access network (LAN), personal access network (PAN), wide area access network (WAN), 3G/4G/5G and Bluetooth.

Preferably, the eyewear case comprises a global positioning system (GPS) unit connected to the one or more rechargeable batteries, computing module, the one or more power output ports and the data storage unit for locating a position of the eyewear case.

Preferably, the eyewear case comprises a light-emitting unit which is configured at the PCB and connected to the switch for controlling the light-emitting unit.

Preferably, the eyewear case comprises a cable containing portion which is configured at one of interior peripheries of the first portion and the second portion for allowing cables to swirl around the cable containing portion.

To sum up, the eyewear case may further recharge or drive other electrically driven devices, be recharged via solar panel or external power source in a variety of ways, store data as a portable data storage, have a compatibility of SIM card, act as a wireless access point as well as a media bridge server, broadcast sounds as a speaker, recording sounds as a recorder, display information in a plurality of forms, locate the position of itself, act as a light source, capable of receiving connection cables, and so forth. Furthermore, all of the aforementioned functions can be included within a centralized housing for protecting the eyewear, so as to improve the convenience thereof by integrating multiple functions into only one apparatus.

### BRIEF DESCRIPTION OF THE DRAWINGS

FIG. 1 is the schematic diagram showing an embodiment of the eyewear case of the present invention;

FIG. 2 is the schematic diagram particularly showing embodiments of the coupling mechanism of the eyewear case of the present invention;

FIG. 3 is the schematic diagram particularly showing an embodiment of the pop-up mechanism of the eyewear case of the present invention;

FIG. 4 is the schematic diagram particularly showing an embodiment of the support unit of the eyewear case of the present invention;

FIG. 5 is the schematic diagram particularly showing an embodiment of the inductive coil of the eyewear case of the present invention;

FIG. 6 is the schematic diagram particularly showing an embodiment of the solar panel of the eyewear case of the present invention;

FIG. 7 is the schematic diagram particularly showing an embodiment of the batteries, light-emitting unit and computing module in the eyewear case of the present invention;

FIG. 8 is the schematic diagram particularly showing an embodiment of the configuration of the data storage unit, computing module, internet connecting module, GPS unit and light-emitting unit in the eyewear case of the present invention;

FIG. 9 is the schematic diagram particularly showing a connection relationship with respect to the internet connecting module in the eyewear case of the present invention;

FIG. 10 is the schematic diagram particularly showing embodiments of the audible unit and display screen in the eyewear case of the present invention.

### DESCRIPTION OF THE PREFERRED EMBODIMENTS

It will be readily understood that the components of the embodiments as generally described and illustrated in the FIGS. herein may be arranged and designed in a wide variety of different configurations in addition to the described exemplified embodiments. Thus, the following more detailed description of the exemplified embodiments, as presented in the FIGS., is not intended to limit the scope of the embodiments, as claimed, but is merely representative of exemplified embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

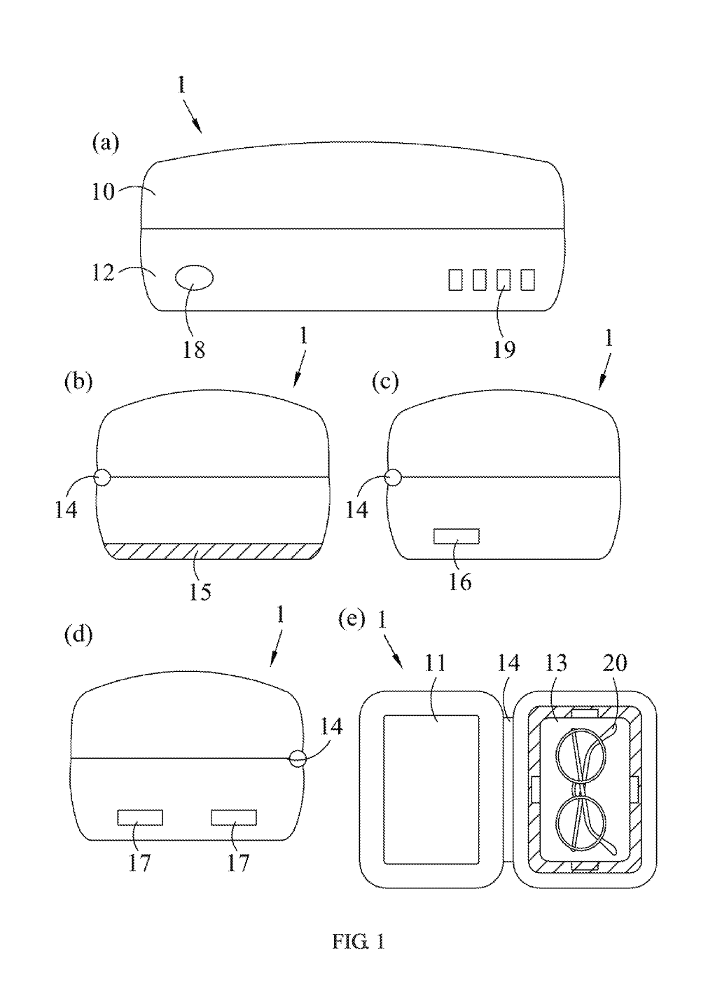

Please refer to FIG. 1, which is the schematic diagram showing an embodiment of the eyewear case of the present invention. As illustrated in the FIGS. 1(a)-(e), an eyewear case 1 for housing an eyewear 20 such as sunglasses, binoculars, monocular or miniature telescopes is suitable for serving as a power source to recharge a variety of electrically driven devices.

Wherein, main elements making up the eyewear case 1 include a first portion 10, a second portion 12, a coupling mechanism 14, one or more rechargeable batteries 15, a power input port 16, two output ports 17, a switch 18 and a battery meter 19. More detailed descriptions with respect to each element listed above will be presented in the following texts.

As shown in FIGS. 1(a) and 1(e) which are the front and top views respectively, the eyewear case 1 comprises a first portion 10 having a first cavity 11 and a second portion 12 having a second cavity 13, wherein the first portion 10 and the second portion 12 are operable to collaboratively enclose an accommodating space which is formed of the first cavity 11 and the second cavity 13 for storing an eyewear 20 or make the accommodating space accessible from outside via operating the coupling mechanism 14. The shapes of first cavity 11 and second cavity 13 may be arbitrary as long as suitable for housing the eyewear 20. That is, although the eyewear case 1 shown in FIG. 1 has two portions positioned in a top-bottom format, it may also be designed in a variety of formats, such as a purse style design, “mummy case” design, tomb style design, wherein the eyewear 20 sits in a bottom of one of the cavities in the portions and is covered by the other portion. For the present invention, a necessity of the eyewear case 1 is that it possesses a hard shell, which can be but need not to be covered by a fabric, to allow for protection of the eyewear 20 as well as the various elements which make up the eyewear case 1. In terms of size, the eyewear case 1 is preferably large enough such that an eyewear 20 can be fit within. However, it is still small enough such that it can be fit within a pocket of a user, if desired.

As shown in FIG. 1(b) which is the cross-section view of the eyewear case 1, the eyewear case 1 includes one or more rechargeable batteries 15, which are configured at the bottom of the second portion 12, wherein the batteries 15 can be one or more of lithium ion, nickel-metal, nickel-cadmium, lead-acid, magnesium batteries, lithium polymer, and other type rechargeable batteries. Due to being configured at the bottom of the second portion 12, it can help stabilize the eyewear case 1 and act as an extra buffer for protecting the eyewear 20. On the other hand, the battery number may range from one to several based on the desired output recharging defined in terms of mAh, which is the amount of power flow supplied at a specific voltage to an electrically driven device. The batteries may be used to recharge an electrically driven device, or may be used to drive an electrically driven device. The recharging and/or driving may also occur while the batteries themselves are being recharged from an external power source. In a preferred embodiment, the mAh amount is up to 20,000 mAh.

As shown in FIGS. 1(c) and 1(d) which are the left and right views of the eyewear case 1 respectively, it includes a power input port 16 and two power output ports 17, wherein the power input port 16 is configured at the left side and lower position of the second portion 12, the two power output ports 17 are configured at the right side and lower position of the second portion 12, and all of them are connected with the batteries 15. Each of the power input port 16 and the power output port 17 has inbuilt circuits to allow for charging the batteries 15 and recharging the multiple-types of electrically driven devices outside. Due to the positions of the power input port 16 and the power output ports 17 are close to the batteries 15, such that the inbuilt circuits can be shortened and simplified to avoid malfunction occurred therein. On the other hand, the types of the power input port 16 and the power output ports 17 are selected from one or more of universal serial bus (USB) 1.0, USB 2.0, USB 3.0, USB 3.1, USB-A, USB-B, USB-mini A, USB-mini B, USB-C and lighting cables, such that the present invention has the ability to connect to a variety of electrically driven devices.

Additionally, as shown in FIG. 1(a), a switch 18 is configured at the front side and left position of the eyewear 1, wherein the switch is electrically connected between the batteries 15 and the power output ports 17. The forms of switch may be one of a toggle switch, pushbutton switch, selector switch, joystick switch and so forth, so as to control an electrical connection between the batteries 15 and the power output ports 17 for recharging the multiple-types of electrically driven devices outside. Besides, a battery meter 19 is configured at the front side and right position of the eyewear 1, wherein the battery meter 19 is electrically connected with the batteries 15 for showing how much electricity is stored in the batteries 15 via a schematic manner. The schematic manner may be one of a colored LED display, a bar-shaped display, a numerical display and so forth.

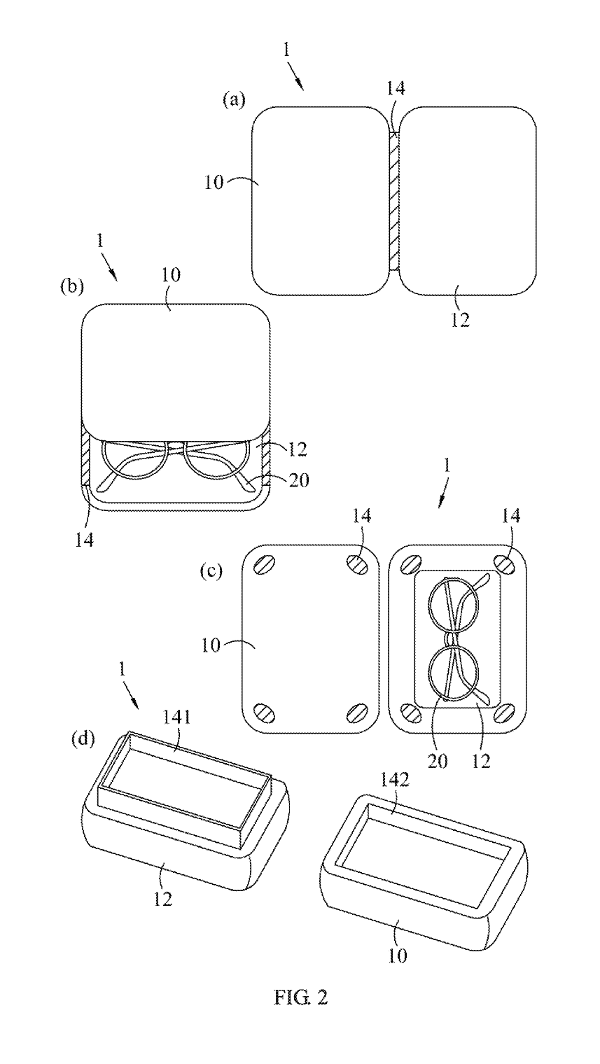

Please refer to FIG. 2, which is the schematic diagram particularly showing several embodiments of the coupling mechanism 14 of the eyewear case 1 of the present invention. The first portion 10 and the second portion 12 described above are coupled by a coupling mechanism 14, wherein the coupling mechanism 14 may be configured in a variety of manners. As shown in FIG. 2(a), the coupling mechanism 14 is a hinge, which is configured between the first portion 10 and the second portion 12 such that the eyewear case 1 may be opened and closed in a rotatable manner. As shown in FIG. 2(b), the coupling mechanism 14 is a sliding mechanism, which has two tracks formed on two opposite sides of each of the first portion 10 and the second portion 12, such that the eyewear case 1 may be opened and closed by moving one of the first portion 10 and the second portion 12 with respect to the other in a sliding manner. As shown in FIG. 2(c), the coupling mechanism 14 comprises a plurality of the magnetized elements, which are distributed on the four corners of each of the first portion 10 and the second portion 12, such that the eyewear case 1 may be opened and closed by magnetism of the magnetized elements. As shown in FIG. 2(D), the coupling mechanism 14 has a male joint 141 on the second portion 12 and a female joint 142 on the first portion 10, such that the eyewear case 1 may be opened and closed by inserting the male joint 141 into the female joint 142.

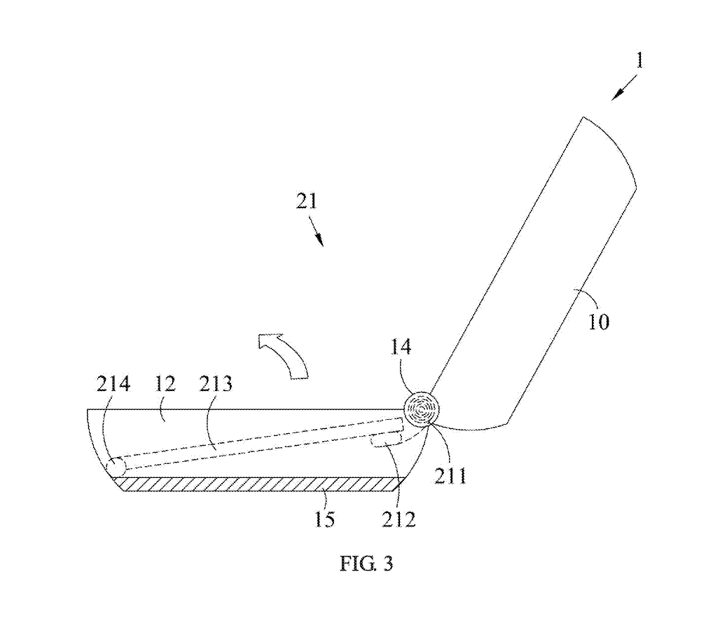

Please refer to FIG. 3, which is the schematic diagram particularly showing to an embodiment of the pop-up mechanism 21 of the eyewear case 1 of the present invention. The pop-up mechanism 21 comprises a driving unit, a buffering unit, a base and a pivot, wherein the driving unit herein is a torsion spring 211 and the buffering unit herein is a soft material 212 like sponge. More specifically, the torsion spring 211 is combined with the coupling mechanism 14 and connected to each of the first portion 10 as well as the base 213, wherein a soft material 212 is interposed between the torsion spring 211 and the base 213, and one end of the base 213 is coupled with the pivot 214 fixed on the second portion 12. When the eyewear case 1 is closed, the torsion spring 211 is in a compressed state and the base 213 lies on the bottom of the second portion 12. When the eyewear case 1 is opened, the torsion spring 211 transfers to a released state, such that as the clockwise rotation of the first portion 10, the torsion spring 211 accordingly drives the base 213 to perform a counterclockwise rotation with respect to the pivot 214 so as to elevate the base 213 and the eyewear put thereon. The soft material 212 acts as a cushion to the contact of the torsion spring 21 land the base 213 in case quick operations of the pop-up mechanism 21 will cause damage to the eyewear. Besides, the pop-up mechanism 21 makes the eyewear more accessible to a user via positioning the eyewear by an oblique angle.

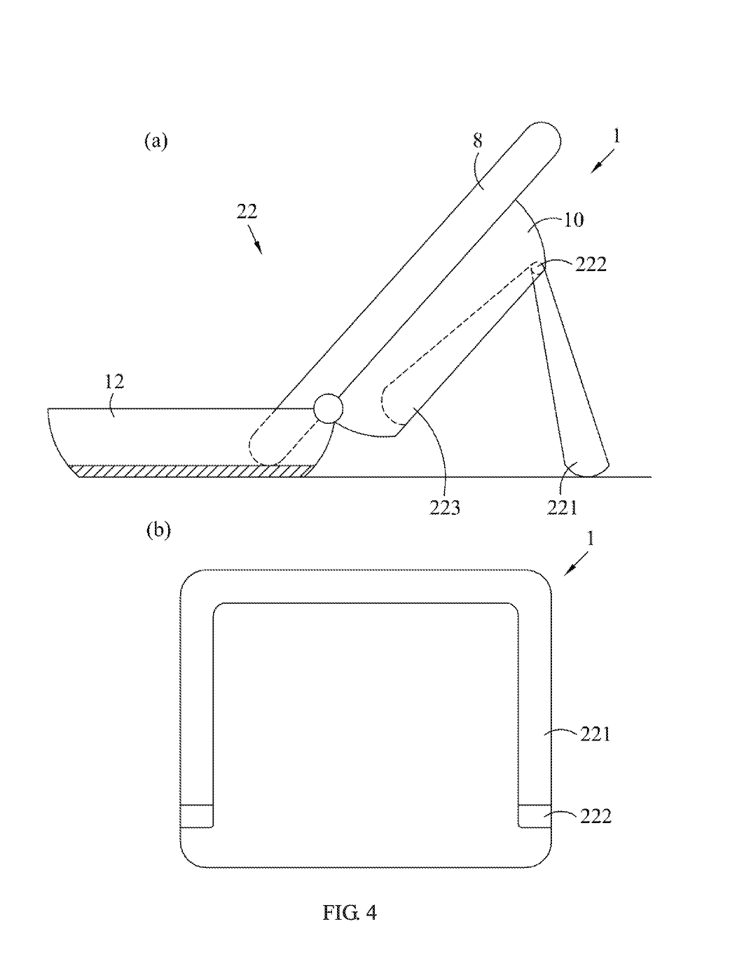

Please refer to FIG. 4, which is the schematic diagram particularly showing an embodiment of the support unit 22 of the eyewear case 1 of the present invention. The support unit 22 comprises a support member 221, a pivot 222 and a recession 223, wherein the support unit 22 is configured at the periphery of the first portion 10, and the support member 221 is coupled with the first portion 10 via the pivot 222 such that the support member 221 may stretch out in a rotatable manner. Besides, the support unit 22 is U-shaped and retrievable, wherein the shape of the recession 223 is the same as the support member 221 so as to receive the support member 221 therein. When the eyewear case 1 is opened and the support member 221 is stretched out, the eyewear case 1 can be stabilized on a ground such that the multiple-types of electrically driven devices 8 can be firmly put thereon by an adjustable oblique angle while these devices 8 are being recharged or not. Additionally, a skid-proof material may be applied to the surface of the support member in contact with the ground and the surface above the batteries 15 in the second portion 12 in contact with these devices 8 in order to further settle down the eyewear case 1 and these devices 8 thereon.

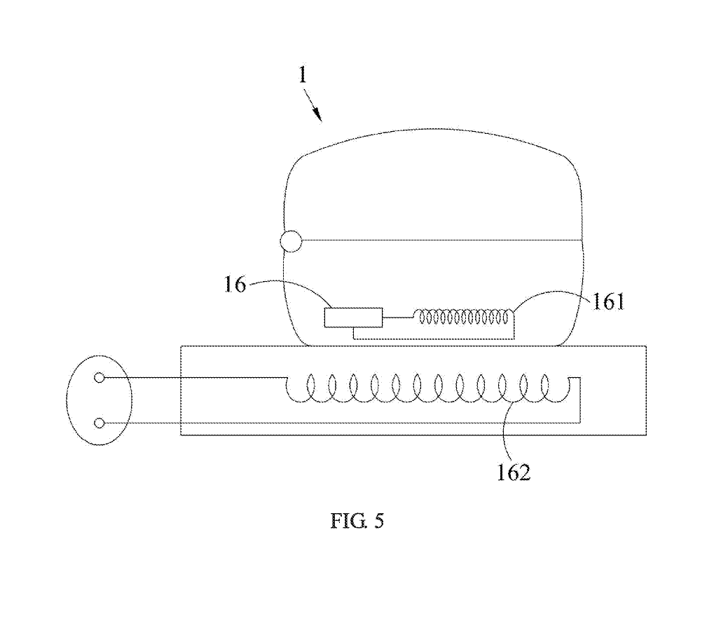

Please refer to FIG. 5, which is the schematic diagram particularly showing an embodiment of the inductive coil of the eyewear case 1 of the present invention. The power input port 16 has a secondary coil 161 and a platform has a primary coil 162, wherein the primary coil 162 of the platform acts as one part of a transformer and the secondary coil 161 of the power input port 16 acts as the other part of the transformer, such that an induction therebetween for recharging the batteries 15 may be performed when the primary coil 162 is connected to an external power source. On the other hand, similar configurations may also be applied to the power output ports 17 separately, such that inductions between the eyewear case 1 and externally compatible devices may be performed for power transmission. That is, the eyewear case 1 can be equipped with the wireless charging/recharging function for receiving/transmitting electricity with respect to devices having the wireless charging/recharging function as well. Besides, while not shown in the figure, electrical circuits allowing for the normal function of inductive charging are substantially provided.

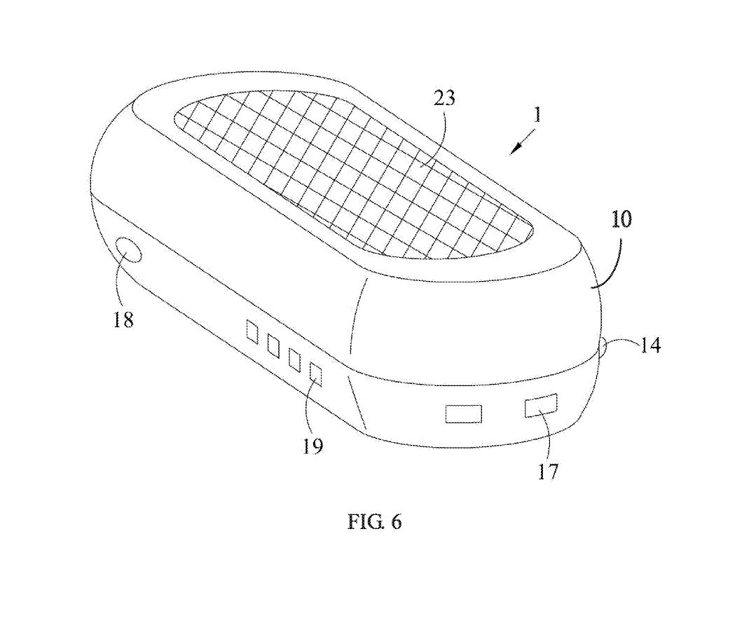

Please refer to FIG. 6, which is the schematic diagram particularly showing an embodiment of the solar panel 23 of the eyewear case 1 of the present invention. The eyewear case 1 has a solar panel 23, which is externally configured on the top of the first portion 10 and connected to the batteries 15. When sunlight strikes on the solar panel 23, it transfers the energy of sunlight into electricity which subsequently recharges the batteries 15. On the other hand, the shape of solar panel 23 need not be a rectangular but can be changeable as desired designs.

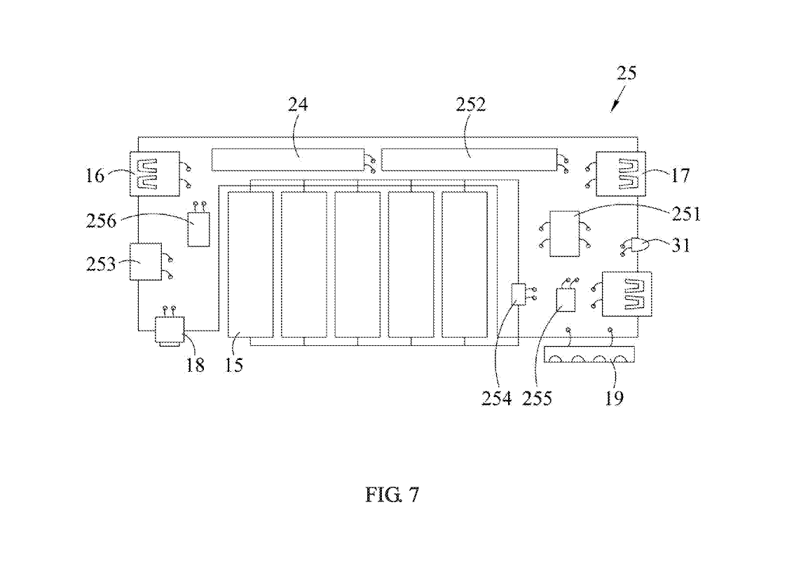

Please refer to FIG. 7, which is the schematic diagram particularly showing an embodiment of the batteries 15 and computing module 25 in the eyewear case 1 of the present invention. The eyewear case 1 comprises a computing module 25 which is a printed circuit board (PCB). The computing module 25 includes a central processing unit (CPU) 251, a memory unit 252 selected from one or more of Cache and random-access memory (RAM), a subscriber identity module (SIM) port 253 configured at the PCB, and a plurality of functional circuits such as a protection circuit 254, a DC-DC converter 255, a charging control circuit 256 and so forth, wherein the computing module 25 is connected to the batteries 15, the power input port 16, power output ports 17, switch 18, battery meter 19, data storage unit 24 and light-emitting unit 31. Due to the operation of the SIM port 253, the eyewear case 1 may connect to external signal sources and external devices through wireless connections such as 3G/4G/5G connections. In case the batteries 15 would explode since generated heat is too much and the batteries 15 would be damaged since the recharging voltage is too low or the charging voltage is too high, the protection circuit 254 may accordingly break the connection between the batteries 15 and the external devices in order to secure the batteries 15 from malfunctions. When the external devices are connected to the batteries 15 via the power output ports 17, the DC-DC converter 255 may spontaneously transfer the voltage of batteries 15 into an appropriate voltage which is suitable for recharging the external devices. When the external power source is connected to the batteries 15 via the power input port 16, the charging control circuit 256 may be utilized to control the charging of batteries 15, for example, a common battery-charging manner which is a three-stage charging management including trickle charging, constant current charging and constant voltage charging can be performed.

More particularly, a smart charging process may be conducted via the computing module 25 described above. In the smart charging process, the batteries 15 and the computing module 25 may communicate with each other as a battery management system (BMS), so as to optimize the charging process, wherein, the BMS can further manage the batteries 15 by a variety of manners, such as protecting the batteries 15 from operating outside their safe operating area, monitoring state thereof, calculating data thereof, reporting the data, adjusting based on the data, and so forth. The communication may be conducted via a standard bus such as a CAN bus and system management bus (SMBus). Consequently, the charging process is controlled by the BMS rather than the charger, so as to enhance the security of the charging process.

On the other hand, when external devices are connected to the eyewear case 1 via the power output ports 17, the eyewear case 1 can detect the types or devices and accordingly recharge the devices at a fastest and safest rate as a smart recharging capability via the operation of BMS. Furthermore, the computing module 25 can also assist with other functions possessed by the eyewear case 1, such as the electricity amount display via the battery meter 19.

As shown in FIG. 7, the eyewear case 1 comprises a light-emitting unit 31, which is configured at the printed circuit board. The light-emitting unit 31 may be a LED and emit light to the surrounding as a light source through the second portion 12.

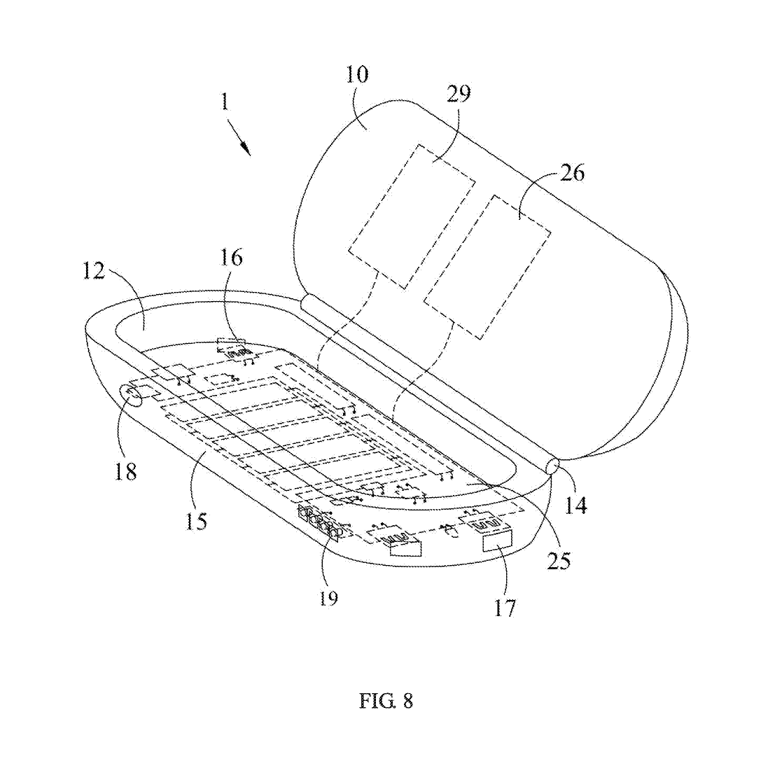

Please refer to FIG. 8, which is the schematic diagram particularly showing an embodiment of the configuration of the data storage unit 24, computing module 25, internet connecting module 26, GPS unit 29 and light-emitting unit 31 in the eyewear case 1 of the present invention. The data storage unit 24 is configured at the printed circuit board in the second portion 12 and connected to the power output ports 17 for storing data from the multiple-types of electrically driven devices when the eyewear case 1 is connected to these devices via the power output ports 17. Besides, the data storage unit 24 is selected from one or more of hard drives, solid state drives (SSD), secure digital (SD) memory cards and universal serial bus (USB) thumb drives.

As shown in FIG. 8, the eyewear case 1 comprises an internet connecting module 26, which is installed in the first portion 10 for distributing external signals to the multiple-types of electrically driven devices as a wireless access point as well as connecting an external signal source with the multiple-types of electrically driven devices as a media bridge server, and connected with the computing module 25 for assisting with performance thereof.

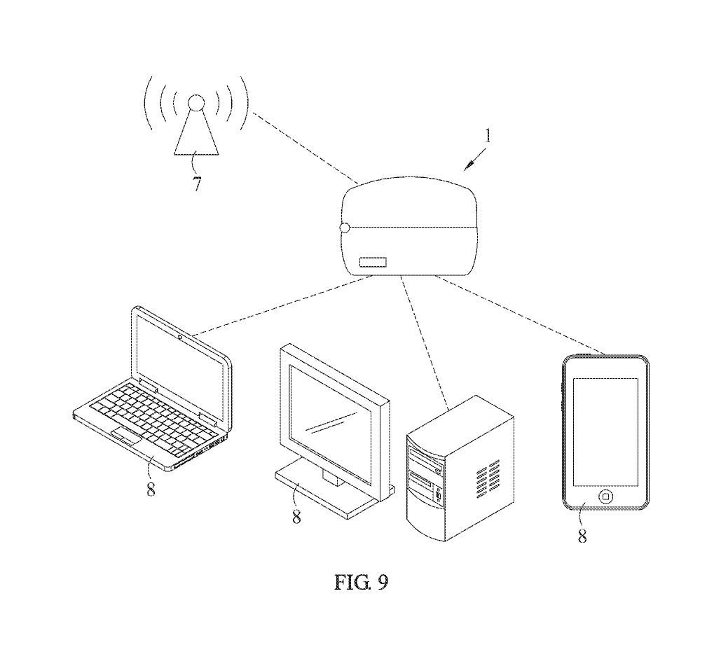

Please refer to FIG. 9, which is the schematic diagram particularly showing a connection relationship with respect to the internet connecting module 26 in the eyewear case 1 of the present invention. The eyewear case 1 may be connected to the internet as a wireless access point for distributing external signals to external devices, i.e. the eyewear case 1 may have the same capability as the external signal source 7 to directly distribute external signals to external devices. Besides, the eyewear case 1 may also act as a wireless media bridge server between the external signal source 7 and the multiple-types of electrically driven devices 8 such as laptops, PCs and smartphones. Due to the capability as a wireless media bridge server, interactive connections between the external signal source 7 and the electrically driven devices 8 may be conducted through the internet connecting module 26 in the eyewear case 1, i.e. data or information can be transmitted therebetween through uploading and downloading. Furthermore, the internet connecting module 26 in the eyewear case 1 can assist with providing a stable wireless signal. Wherein, the form of wireless connection is selected from one or more of 3G/4G/5G connections, Zigbee protocol, wireless fidelity protocol (WIFI), local access network (LAN), personal access network (PAN), wide area access network (WAN), 3G/4G/5G and Bluetooth.

As shown in FIG. 8, the eyewear case 1 comprises a GPS unit 29, which is configured in the first portion 10 and connected to the batteries 15, computing module 25, power output ports 17 and the data storage unit 24 for locating the position of the eyewear case 1. Hence, a user can find the position of the eyewear case 1 on his/her electrically driven devices such as laptops, PCs and smartphones via the wireless connection conducted by the internet connecting module 26.

Additionally speaking, FIG. 8 is used to specifically illustrate certain components inside the eyewear case 1. That is, extra configurations or decorations may be applied to the eyewear case 1 in the substantial conditions.

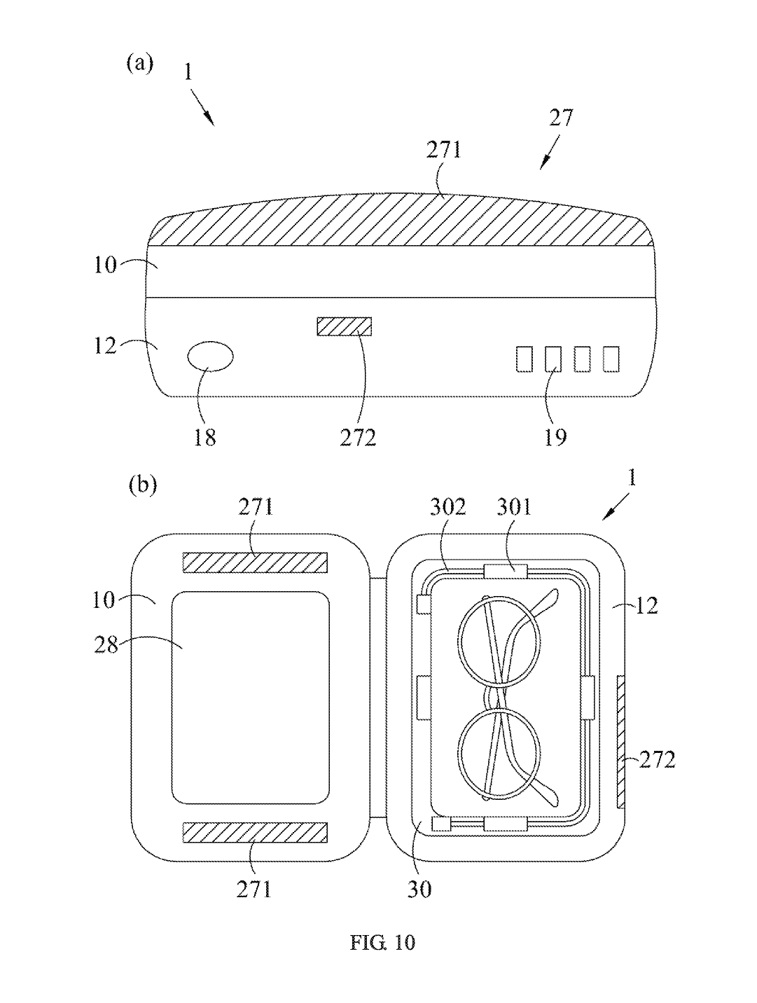

Please refer to FIG. 10, which is the schematic diagram particularly showing embodiments of the audible unit 27 and display screen 28 in the eyewear case 1 of the present invention.

As shown in FIG. 10(a) which presents an embodiment of the audible unit 27 of the eyewear case 1, the eyewear case 1 comprises an audible unit 27 including a speaker 271 and a microphone 272, wherein the speaker 271 is externally configured on the top of the first portion 10 and the microphone 272 is configured on the front of the second portion 12. Besides, the eyewear case 1 is connected to the data storage unit 24, the computing module 25 as well as the internet connecting module 26 for broadcasting sounds according to data from the data storage unit 24, the external signal source as well as the power output ports 17 and recording external sounds on the data storage unit 24. That is, the user can broadcast sounds via either wireless connection or cable connection. Due to the aforementioned configuration, a user can easily broadcast and record sounds even if the eyewear case 1 is closed. Additionally, the switch 18 can further be configured as a knob so as to control the volume of sounds by turning the knob.

As shown in FIG. 10(b) which presents another embodiment of the audible unit 27 integrated with the display screen 28 in the eyewear case 1, the display screen 28 is configured on the interior of the first portion 10 while the speaker 271 herein is separately configured on two opposite sides of the display screen 28 and the microphone 272 is configured on the front of the second portion 12. In addition to the electrical connections described in FIG. 9(a), the eyewear case 1 is further connected to the audible unit 27 and the display screen 28, such that information such as texts, photos and videos can be displayed and accessible according to data from the data storage unit 24, the external signal source and the power output ports 17. Due to such a configuration, a user can easily reach his/her eyewear without searching for them when he/she wants to read texts, see photos, watch videos, and listen to radios or sound tracks at the same time, if desired.

Last but not least, as shown in FIG. 10(b), the eyewear case 1 comprises a cable containing portion 30 which is configured at the interior periphery of the second portion 12, wherein the cable containing portion 30 further includes four protrusions 301 formed on each of the four sides respectively for holding the cables 302, such that the cables 302 can be neatly swirled around the cable containing portion 30. Besides, the cables 302 have at least one coupling joint corresponding to the power input port 16 and the power output ports 17 while the other coupling joints thereof are suitable for connecting the electrically driven devices, or connecting wirings of these devices may also be deposited in the cable containing portion 30.

The apparatus of the present invention has many embodiments, aside from the size, shape, and orientation of the eyewear case 1. Similarly, the accommodating space within the eyewear case 1 can also be used to house other tools, such as light or mp3 player and so forth.

In short, the present invention relates to an apparatus having multi-uses including the protection of eyewear, the ability to recharge and drive electrically driven devices, the ability to support and fix these devices thereon by a suitable angle for a user, a wide range of compatibilities to these devices, the ability to store data, the ability to control and adjust charging/recharging conditions, the ability to broadcast audible sounds, the ability to display a variety of information and so forth, wherein the apparatus can also be recharged by either an external power source or a solar panel.

The present invention means to solve the problem of having eyeglass wearers carry only a case just for protection of their eyewear, while at the same time having to carry items they may need such as portable charger, speaker, etc.

For example, the apparatus of the present invention is particularly useful when going on daily outings or activities. Under those conditions, the user desires to carry a portable charger for one or more of his electrically driven devices such as a speaker for music, and desires to have these devices be readily rechargeable, so that all the demands can be achieved by utilizing the present invention while being able to protect his eyewear as well. An example of such an outing would be a day at a beach.

Although various embodiments of the present invention have been shown and described above, modifications may occur to those skilled in the art upon reading the specification. The present invention is meant to include such modifications and only be limited by the scope of the claims. That is, the description above is merely for exemplification rather than limitation of the present invention. Therefore, any equivalent modification or changing performed to the present invention without departing from the spirit and scope defined by the present invention should be included in the appending claims below.

What is claimed is:

1. An eyewear case for driving and recharging multiple-types of electrically driven devices, comprising:
a first portion having a first cavity;
a second portion having a second cavity;
a coupling mechanism joining the first portion and the second portion together;
one or more rechargeable batteries configured at one or both of the first portion and the second portion;
an power input port configured at one of the first portion and the second portion, electrically connecting with the one or more rechargeable batteries;
one or more power output ports configured at one or both of the first portion and the second portion, electrically connecting with the one or more rechargeable batteries;
a switch configured at one or both of the first portion and the second portion, electrically connected between the one or more rechargeable batteries and the one or more power output ports to control an electrical connection therebetween for recharging the multiple-types of electrically driven devices; and
a battery meter configured at an exterior of one or both of the first portion and the second portion;
wherein the first portion and the second portion are operable to collaboratively enclose an accommodating space which is formed of the first cavity and the second cavity for storing an eyewear, or make the accommodating space accessible from outside by operating the coupling mechanism.

2. The eyewear case of claim 1, wherein the coupling mechanism is selected from one or more of a hinge for coupling the first portion and the second portion in a rotatable manner, a sliding mechanism for coupling the first portion and the second portion in a sliding manner, a pair of magnetized elements configured on the first portion and the second portion respectively, and a male joint as well as a female joint formed on the first portion and the second portion respectively so as to couple the first portion and the second portion by inserting the male joint into the female joint.

3. The eyewear case of claim 2, further comprising a pop-up mechanism which is connected to the coupling mechanism, such that the pop-up mechanism sticks out the eyewear stored in the accommodating space when the accommodating space becomes accessible from outside by operating the coupling mechanism and retrieves the eyewear back to the accommodating space when the accommodating space becomes enclosed by operating the coupling mechanism.

4. The eyewear case of claim 2, further comprising a support unit which is configured at the exterior of one of the first portion and the second portion for fixing one of the first portion and the second portion by an oblique angle with respect to each other, so as to support the multiple-types of electrically driven devices put thereon, wherein the support unit is retrievable.

5. The eyewear case of claim 1, wherein the power input port and the one or more power output ports are selected from one or more of universal serial bus (USB) 1.0, USB 2.0, USB 3.0, USB 3.1, USB-A, USB-B, USB-mini A, USB-mini B, USB-C, and lighting cables.

6. The eyewear case of claim 1, wherein both the power input port and the one or more power output ports have inductive coils which are electrically connected with an external power source and the multiple-types of electrically driven devices respectively.

7. The eyewear case of claim 1, further comprising a solar panel configured on the exterior of one or both of the first portion and the second portion, wherein the solar panel is electrically connected to the one or more rechargeable batteries.

8. The eyewear case of claim 1, further comprising a data storage unit selected from one or more of hard drives, solid state drives (SSD), secure digital (SD) memory cards and universal serial bus (USB) thumb drives.

9. The eyewear case of claim 8, further comprising a computing module which is a printed circuit board (PCB), the computing module including:
a central processing unit (CPU);
a memory unit selected from one or more of Cache and random-access memory (RAM);
a subscriber identity module (SIM) port configured at the PCB; and
a plurality of functional circuits for performing controls of charging the batteries and recharging the multiple-types of electrically driven devices;
wherein the computing module is connected to the one or more rechargeable batteries, the power input port, the one or more power output ports, the switch, the battery meter and the data storage unit.

10. The eyewear case of claim 9, further comprising an internet connecting module, which distributes external signals to the multiple-types of electrically driven devices as a wireless access point, and connects an external signal source with the multiple-types of electrically driven devices as a media bridge server.

11. The eyewear case of claim 10, further comprising an audible unit configured at one or both of the first portion and the second portion, wherein the audible unit includes a speaker as well as a microphone, and connected to the data storage unit, the computing module as well as the internet connecting module for broadcasting sounds according to data from the data storage unit, the external signal source as well as the one or more power output ports and recording external sounds on the data storage unit.

12. The eyewear case of claim 10, further comprising a display screen which is configured at one or both of the first portion and the second portion, wherein the display screen is connected to the data storage unit, the computing module, the internet connecting module and the audible unit for displaying information selected from one or more of texts, photos and videos according to the data from the data storage unit, the external signal source as well as the one or more power output ports.

13. The eyewear case of claim 10, wherein connecting types to the external signal source is selected from one or more of hardwire, Zigbee protocol, wireless fidelity (WIFI) protocol, local access network (LAN), personal access network (PAN), wide area access network (WAN), 3G/4G/5G and Bluetooth.

14. The eyewear case of claim 9, further comprising a global positioning system (GPS) unit connected to the one or more rechargeable batteries, the computing module, the one or more power output ports and the data storage unit for locating a position of the eyewear case.

15. The eyewear case of claim 9, further comprising a light-emitting unit which is configured at the PCB and connected to the switch for controlling the light-emitting unit.

16. The eyewear case of claim 1, further comprising a cable containing portion which is configured at one of interior peripheries of the first portion and the second portion for allowing cables to swirl around the cable containing portion.
